(19) United States
(12) Patent Application Publication
(10) Pub. No.: US 2010/0171410 A1
(43) Pub. Date: Jul. 8, 2010

(54) LIGHT EMISSION DEVICE

(76) Inventors: Kyung-Sun Ryu, Suwon-si (KR); Hyeong-Rae Seon, Suwon-si (KR); Dong-Su Chang, Suwon-si (KR)

Correspondence Address: CHRISTIE, PARKER & HALE, LLP, PO BOX 7068, PASADENA, CA, 91109-7068, US

(21) Appl. No.: 12/649,300

(22) Filed: Dec. 29, 2009

(30) Foreign Application Priority Data
Jan. 6, 2009 (KR) 10-2009-0000787

(51) Int. Cl. H01J 5/00

(52) U.S. Cl. 313/317

(57) ABSTRACT

A light emitting device includes first and second substrates facing each other, and a sealing member interposed between the first and second substrates. The sealing member includes a first supporting frame having a groove portion and a second supporting frame having an end inserted into the groove portion, and an external surface of an end of the second supporting frame, inserted into the groove portion, is surrounded by the first supporting frame.

### CROSS-REFERENCE TO RELATED APPLICATIONS

This application claims priority to and the benefit of Korean Patent Application No. 10-2009-0000787, filed in the Korean Intellectual Property Office, on Jan. 6, 2009, the entire content of which is incorporated herein by reference.

### BACKGROUND

1. Field

The described technology relates generally to a light emitting device. More particularly, it relates to a sealing member that is disposed between a front substrate and a rear substrate and seals the two substrates.

2. Description of the Related Art

There are many different types of light emission devices that radiate visible light. In one embodiment, a light emission device includes an anode electrode and a phosphor layer that are disposed on a front substrate and an electron emission unit and a driving electrode that are disposed on a rear substrate has been disclosed. The front and rear substrates are sealed to each other at their peripheries using a sealing member, and the inner space between the first and second substrates is exhausted to form a vacuum chamber for smooth emission and movement of electrons.

The sealing member may have a structure in which bar-shaped supporting frames are adhered to each other. For example, the sealing member may be formed of two supporting frames disposed at edge portions of long sides of the front and rear substrates, and two supporting frames disposed at edge portions of short sides of the front and rear substrates. Each supporting frame is made of glass or ceramic, and frit adhesive layers are disposed on top and bottom sides of the supporting frame and an adhering surface of a neighboring supporting frame.

A suitable manufacturing process of a vacuum chamber is as follows. \textcircled{1} Four supporting frames on which the frit adhesive layers are coated are disposed on a first substrate (e.g., one of a rear substrate or a front substrate). \textcircled{2} The supporting frames are fixed to the first substrate by melting the frit adhesive layers through a thermal treatment process and simultaneously the four supporting frames are adhered to each other. \textcircled{3} A second substrate (e.g., the other one of the rear substrate or the front substrate) is disposed on the supporting frames. \textcircled{4} The second substrate and the supporting frames are fixed to each other by melting the adhesive layers through the thermal treatment process.

However, the above-described supporting frames do not have binding force with respect to each other before the melting (i.e., before the thermal treatment process is applied), and therefore, the frames may be individually moved during the thermal treatment process(es) that may be performed several times through the manufacturing process of the light emitting device. That is, the supporting frames individually have mobility during the thermal treatment process. Therefore, even though initial arrangement of one supporting frame is completed, separation may still occur between other supporting frames and the arranged one supporting frame, and therefore proper vacuum sealing may not be realized in the follow-up exhausting process.

The above information disclosed in this Background section is only for enhancement of understanding of the background of the described technology and therefore it may contain information that does not form the prior art that is already known in this country to a person of ordinary skill in the art.

### SUMMARY OF THE INVENTION

An aspect of an embodiment of the present invention is directed toward a light emitting device that can suppress separation of supporting frames and sealing errors due to the separation by preventing individual movement of the supporting frames during a thermal treatment process.

A light emitting device according to an exemplary embodiment includes a first substrate and a second substrate facing each other, and a sealing member interposed between the first and second substrates. The sealing member includes a first supporting frame having a groove portion, and a second supporting frame having an end inserted into the groove portion. An external surface of the end of the second supporting frame, inserted into the groove portion, is surrounded by the first supporting frame.

In one embodiment, the first groove portion has a first depth that is smaller than the width of the first supporting frame, and the width of the first groove portion corresponds to the width of the second supporting frame. The sealing member may further include frit adhesive layers on adhering surfaces of the first and second supporting frames and on top and bottom sides of the first and second supporting frames, facing the first and second substrates.

In one embodiment, the first supporting frame includes a first side portion, and the second supporting frame includes a second side portion connected to the first side portion and perpendicularly crossing the first side portion. The first side portion may be a long side portion, and the second side may be a short side portion.

In one embodiment, the first groove portion is at an end and in an inner surface of the long side portion, and a second groove portion is at an end and in an inner surface of the short side portion.

In one embodiment, the second supporting frame has a second groove portion in which an end of the first supporting frame is inserted, and an external surface of the end of the first supporting frame inserted into the second groove portion is surrounded by the second supporting frame.

In one embodiment, the first groove portion of the first supporting frame is at an end and in an inner surface of the long side portion of the first supporting frame, and the second groove portion of the second supporting frame is at an end and in an inner surface of a long side portion of the second supporting frame.

In one embodiment, the first groove portion of the first supporting frame is at an end and in an inner surface of a short side portion of the first supporting frame, and the second groove portion of the second supporting frame is at an end and in an inner surface of the short side portion of the second supporting frame.

In one embodiment, the sealing member further includes a third supporting frame and a fourth supporting frame, the second supporting frame has a second groove portion in which an end of the third supporting frame is inserted, the third supporting frame has a third groove portion in which an end of the fourth supporting frame is inserted, the fourth supporting frame has a fourth groove portion in which an end of the first supporting frame is inserted, and external surfaces of the ends of the third, fourth, and first supporting frames are surrounded by the second, third, and fourth supporting frames. Each of the first, second, third, and fourth supporting frames may have a bar shape. The first groove portion of the first supporting frame may be at an end and in an inner surface of the first supporting frame, the second groove portion of the second supporting frame may be at an end and in an inner surface of the second supporting frame, the third groove portion of the third supporting frame may be at an end and in an inner surface of the third supporting frame, and the fourth groove portion of the fourth supporting frame may be at an end and in an inner surface of the fourth supporting frame.

In one embodiment, the light emitting device further includes an electron emitting unit at one side of the first substrate facing the second substrate. Here, the electron emitting unit includes: a cathode electrode in a recess portion formed in the one side of the first substrate; an electron emission region on the cathode electrode; and a gate electrode fixed onto the one side of the first substrate along a direction that crosses the cathode electrode, and having a mesh structure including a plurality of openings.

### BRIEF DESCRIPTION OF THE DRAWINGS

FIG. 1 is an exploded perspective view of a light emitting device according to a first exemplary embodiment.

FIG. 2 is a top plan view of an assembling state of first and second frames to a second substrate of the light emitting device of FIG. 1.

FIG. 3 is a top plan view of a light emitting device according to a second exemplary embodiment.

FIG. 4 is a top plan view of a light emitting device according to a third exemplary embodiment.

FIG. 5 is a top plan view of a light emitting device according to a fourth exemplary embodiment.

FIG. 6 is an exploded perspective view of a sealing member of FIG. 5.

FIG. 7 is a partially cut-away perspective view of an electron emitting unit and a light emitting unit of a light emitting device according to an exemplary embodiment.

FIG. 8 is a partial cross-sectional view of the electron emitting unit and the light emitting unit of the light emitting device according to the exemplary embodiment.

FIG. 9 is an exploded perspective view of a display device according to the exemplary embodiment.

FIG. 10 is a partial cross-sectional view of a display panel of FIG. 9.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when an element is referred to as being “on” another element, it can be directly on the another element or be indirectly on the another element with one or more intervening elements interposed therebetween. Like reference numerals designate like elements throughout the specification.

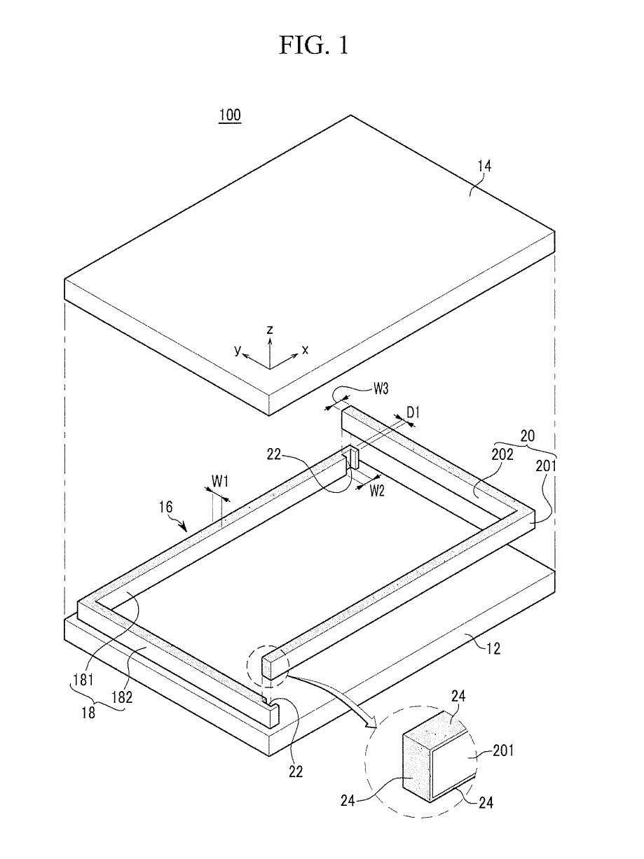

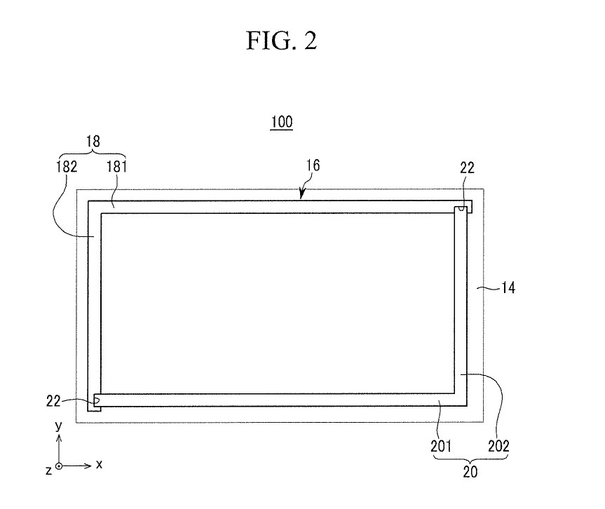

FIG. 1 is an exploded perspective view of a light emitting device 100 according to a first exemplary embodiment, and FIG. 2 is a top plan view of an assembling state of first and second supporting frames 18 and 20 to a second substrate 14 of the light emitting device 100 of FIG. 1.

Referring to FIG. 1 and FIG. 2, the light emitting device 100 includes a first substrate 12 and the second substrate 14 that face each other. A sealing member 16 is disposed at edge portions (or at edges) of the first and second substrates 12 and 14 to seal the two substrates 12 and 14, and an inner space formed between the first and second substrates is exhausted to a vacuum degree of about 10⁻⁶ Torr to thereby form a vacuum chamber.

An electron emitting unit for emitting electrons is disposed on one side of the first substrate 12 facing toward the second substrate 14, and a light emitting unit for emitting visible light is disposed on one side of the second substrate 14 facing toward the first substrate 12. The second substrate 14 where the light emitting unit is disposed may be a front substrate of the light emitting device 100.

In the first exemplary embodiment, the sealing member 16 is formed of two mechanically combined supporting frames, that is, the first supporting frame 18 and the second supporting frame 20. One of the first supporting frame 18 or the second supporting frame 20 (e.g., the first supporting frame 18) has a groove portion 22 formed in an inner surface thereof, and an end of the other (e.g., the second supporting frame 20) is inserted into the groove portion 22 so that the first and second supporting frames 18 and 20 are combined and physically coupled with each other.

Each of the first supporting frame 18 and the second supporting frame 20 includes a first side portion and a second side portion that is perpendicularly connected to the first side portion. The first side portion may be longer than the second side portion. Hereinafter, the first side portion is referred to as a long side portion, and the second side is referred to as a short side portion. Long side portions 181 and 201 of the first and second supporting frames 18 and 20 are disposed corresponding to long sides of the first and second substrates 12 and 14, and short side portions 182 and 202 of the first and second supporting frames 18 and 20 are disposed corresponding to short sides of the first and second substrates 12 and 14.

The first supporting frame 18 and the second supporting frame 20 have the same thickness and width, and are made of an insulator having high compressive strength such as glass and/or ceramic. The thickness of each of the first supporting frame 18 and the second supporting frame 20 may be about less than or equal to 1 mm.

At an inner surface of one of the first and second supporting frames 18 and 20, for example, at an inner surface of the first supporting frame 18, two groove portions 22 are formed. A groove portion 22 is formed at one end of each of the long side portion 181 and the short side portion 182 of the first supporting frame 18. The other supporting frame, that is, the second frame 20, has a width that is constant along the length thereof direction (i.e., the x axis direction for the long side portion 201 and the y axis direction for the short side portion 202 in the drawing).

A depth D1 of the groove portion 22 is smaller than a width W1 (refer to FIG. 1) of the first supporting frame 18, and the width W2 of the groove portion 22 corresponds to a width W3 (refer to FIG. 1) of the second supporting frame 20. Here, the width W2 of the groove portion 22 corresponds to the width W3 of the second supporting frame 20, and the width W2 of the groove portion 22 has some insertion space in addition to the width W3 of the second supporting frame 20 so that the second supporting frame 20 can be inserted into the groove portion 22.

In the first exemplary embodiment, the sealing member 16 is formed by inserting lateral ends of the long side portion 201 and the short side portion 202 of the second supporting frame 20 into the lateral groove portions 22 of the first supporting frame 18, and in this case, external surfaces of the lateral ends of the second supporting frame 20 are surrounded by the first supporting frame 18. Accordingly, the combination state of the first and second supporting frames 18 and 20 cannot be easily separated.

A frit adhesive layer 24 including a glass frit is formed on each of upper and lower surfaces of the first and second supporting frames 18 and 20. In addition, the frit adhesive layer 24 is also formed on an adhering surface of the first and second supporting frames 18 and 20. Here, the adhering surface corresponds to an external surface of an end of the long side portion 201 and an external surface of an end of the short side portion 202 of the second supporting frame 20 that are inserted into the groove portions 22.

A manufacturing process of a vacuum chamber by using the first and second supporting frames 18 and 20 is described in more detail below.

First, the first and second supporting frames 18 and 20 are manufactured by processing an insulator such as glass or ceramic. The frit adhesive layers 24 are coated on the upper and lower surfaces of the first and second supporting frames 18 and 20 and the external surface of the end of the second supporting frame 20 (i.e., the adhering surface with the first supporting frame 18). Then, organic components such as a vehicle included in the frit adhesive layers 24 are eliminated by pre-baking the frit adhesive layers 24 through a thermal treatment process.

Subsequently, the first substrate 12 where the electron emitting unit is formed and the second substrate 14 where the light emitting unit is formed are prepared. In addition, the first supporting frame 18 and the second supporting frame 20 are disposed on one (e.g., the second substrate 14) of the first and second substrates 12 and 14. In this case, the end of the second supporting frame 20 is inserted into the groove portion 22 formed in the first supporting frame 18 to thereby mechanically combine the first and second supporting frames 18 and 20 (refer to FIG. 2).

Subsequently, the first and second frames 18 and 20 are adhered to the second substrate 14 by melting the frit adhesive layers 24 through the thermal treatment process. Then, the first substrate 12 is disposed on the first and second supporting frames 18 and 20, and the first and second supporting frames 18 and 20 are adhered to the first substrate 12 by melting the frit adhesive layers 24 through the thermal treatment process. Through such a thermal treatment process, the first supporting frame 18 and the second supporting frame 20 are adhered to each other by the frit adhesive layer 24 disposed on the adhering surface therebetween so that the sealing member 16 is formed.

As described, in the light emitting device 100 according to an exemplary embodiment, the thermal treatment process is performed while the first and second supporting frames 18 and 20 are mechanically combined, and therefore individual movement of the first and second supporting frames 18 and 20 can be prevented. This is because the mechanical combination force of the first and second supporting frames 18 and 20 eliminates mobility of the first and second supporting frames 18 and 20.

In addition, when mobility is given to the first and second supporting frames 18 and 20 due to the melting of the frit adhesive layer 24 and pressure applied to the first and second supporting frames 18 and 20, the first and second supporting frames 18 and 20 can maintain the rectangular frame shape without being distorted with respect to each other. Accordingly, in the light emitting device 100, generation of a gap in the sealing member 16 can be reduced or prevented so that vacuum sealing can be realized in a following gas exhausting process.

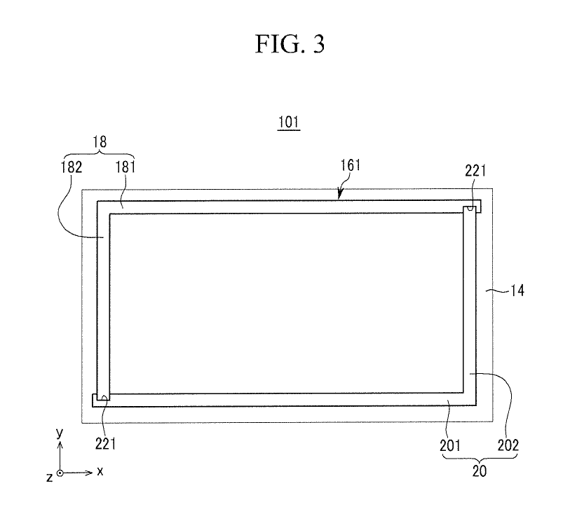

Referring to FIG. 3 to FIG. 6, various other exemplary embodiments of a sealing member are described in more detail below.

FIG. 3 is a top plan view of a light emitting device 101 according to a second exemplary embodiment.

Referring to FIG. 3, the light emitting device 101 has substantially the same configuration as the light emitting device 100, except that a groove portion 221 of a sealing member 161 is formed at an end of a long side portion 181 of a first supporting frame 18 and at an end of a long side portion 201 of a second supporting frame 20. The same members as in the light emitting device 100 are designated by the same reference numerals.

In the second exemplary embodiment, an end of a short side portion 202 of the second supporting frame 20 is inserted into the groove portion 221 formed in the long side portion 181 of the first supporting frame 18, and an end of a short side portion 182 of the first supporting frame 18 is inserted into the groove portion 221 formed in the long side portion 201 of the second supporting frame 20. In a like manner, the first supporting frame 18 and the second supporting frame 20 are combined with each other so that the sealing member 161 is formed.

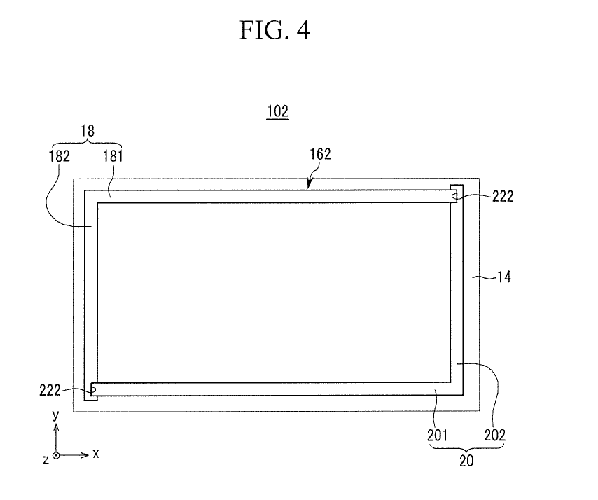

FIG. 4 is a top plan view of a light emitting device 102 according to a third exemplary embodiment.

Referring to FIG. 4, the light emitting device 102 has substantially the same configuration as the light emitting device 100, except that a groove portion 222 of a sealing member 162 is formed at an end of a short side portion 182 of a first supporting frame 18 and at an end of a short side portion 202 of a second supporting frame 20. The same members as in the light device 100 are designated by the same reference numerals.

In the present exemplary embodiment, an end of a long side portion 181 of the first supporting frame 18 is inserted into the groove portion 222 formed in the short side portion 202 of the second supporting frame 20 and an end of a long side portion of the second supporting frame 20 is inserted into the groove portion 222 formed in the short side portion 182 of the first supporting frame 18. In a like manner, the first supporting frame 18 and the second supporting frame 20 are combined with each other so that the sealing member 162 is formed.

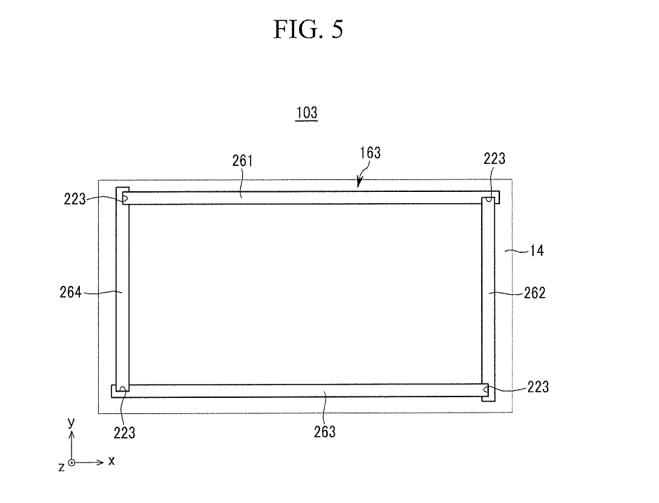

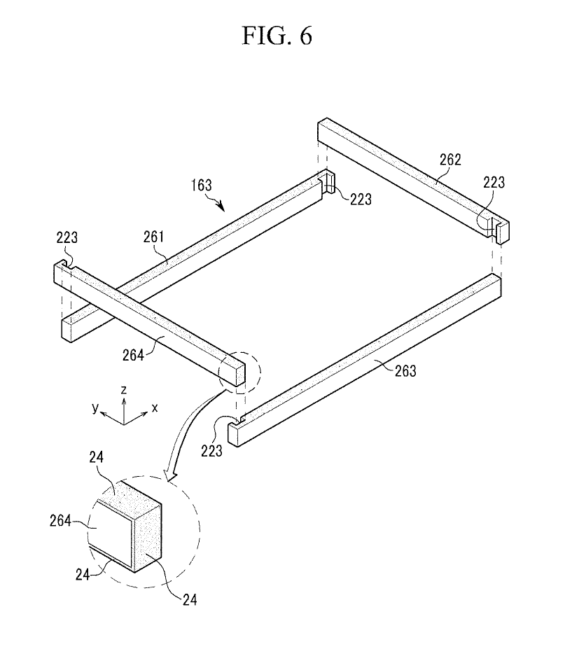

FIG. 5 is a top plan view of a light emitting device 103 according to a fourth exemplary embodiment, and FIG. 6 is an exploded perspective view of a sealing member 163 of FIG. 5.

Referring to FIG. 5 and FIG. 6, the sealing member 163 of the light emitting device 103 includes four bar-shaped supporting frames, that is, first to four supporting frames 261, 262, 263, and 264. Two (261 and 263) of the first to fourth supporting frames 261, 262, 263, and 264 are disposed at long side portions of first and second substrates 12 and 14, and the other two (262 and 264) are disposed at short side portions of the first and second substrates 12 and 14.

Each of the first to fourth supporting frames 261, 262, 263, and 264 has a groove portion 223 formed in an inner surface of an end thereof so that an end of a perpendicularly neighboring supporting frame is inserted therein. Frit adhesive layers 24 are disposed on the upper and lower surfaces and at external surfaces of the ends of the first to fourth supporting frames 261, 262, 263, and 264 that are inserted into the groove portions 223.

When the sealing member 163 is formed of four supporting frames 261, 262, 263, and 264, the four supporting frames 261, 262, 263, and 264 can maintain a rectangular frame shape without individual movement during a thermal treatment process by mechanical combination force therebetween.

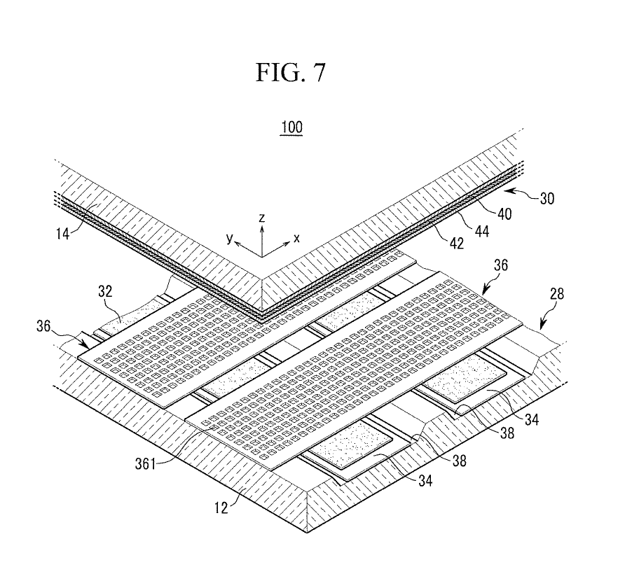

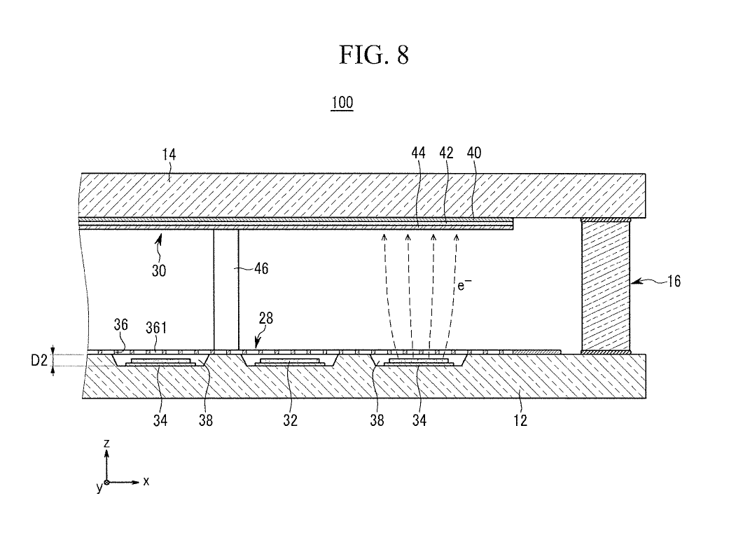

An internal structure of a light emitting device with application of the previously described sealing member is described in more detail with reference to FIG. 7 and FIG. 8. In the following light emitting device, a sealing member can be formed of one of the previous four sealing members.

FIG. 7 and FIG. 8 respectively show a partially cut-away perspective view and a partial cross-sectional view of an electron emitting unit 28 and a light emitting unit 30 of the light emitting device 100 according to an exemplary embodiment. In FIG. 7 and FIG. 8, the same members as in the light emitting device 100 as described above are designated by the same reference numerals.

Referring to FIG. 7 and FIG. 8, the electron emitting unit 28 and the light emitting unit 30 are respectively disposed at an inner surface of the first substrate 12 and an inner surface of the second substrate 14 and in an inner region defined by the sealing member 16.

The electron emitting unit 28 includes electron emitters 32 and driving electrodes that control the current amount with respect to electron emission of the electron emitters 32. The driving electrodes includes cathode electrodes 34 formed in a stripe pattern along a first direction (e.g., y axis direction of the drawing) and gate electrodes 36 formed in a stripe pattern on upper portions of the cathode electrodes 34, along a second direction (e.g., x axis in the drawing) that crosses the first direction of the cathode electrodes 34.

The first substrate 12 has a recess portion 38 having a certain or predetermined depth D (refer to FIG. 8) formed in an inner surface that faces the second substrate 14 to dispose the cathode electrode 34 in the bottom surface of the recess portion 38. The recess portion 38 may be formed by partially eliminating the first substrate by using an etching method or a sand blast method, and is formed in a stripe pattern along the length direction of the cathode electrode 34.

The width of the recess portion 38 is larger than that of the cathode electrode 34, and the depth thereof is larger than a sum of the thickness of the cathode electrode 34 and the thickness of the electron emission region 32. The recess portion 38 may have a perpendicular or inclined side wall. In FIG. 7 and FIG. 8, the recess portion 38 exemplarily has an inclined side wall.

As described, the cathode electrode 34 disposed on the bottom surface of the recess portion 38 is lower by a certain or predetermined height difference than an upper surface (i.e., an inner surface of the first substrate 12 where the recession portion 38 is not formed) of the first substrate 12. In addition, a portion of the first substrate 12, disposed between the recess portions 38 form a relatively convex portion, and the convex portion functions as a barrier for separating neighboring cathode electrodes 34 from each other.

The electron emission region 32 may be formed on the cathode electrode 34 in a stripe pattern parallel to the cathode electrode 34. Alternatively, the electron emission region 32 may be partially formed on the cathode electrode 34, corresponding to a crossing region of the cathode electrode 34 and the gate electrode 36. FIG. 7 exemplarily shows that the electron emission region 32 is formed in a stripe pattern.

The electron emission region 32 includes a material that emits electrons when an electric field is applied in a vacuum condition. Here, the material includes a carbon-based material and/or a nanometer (nm)-sized material. The electron emission region 32 may for example include a material selected from a group of carbon nanotubes, graphite, graphite nanofiber, diamond, diamond-like carbon, silicon nanowire, or combinations thereof.

As the depth D2 of the recess portion 38 is larger than the sum of the thickness of the cathode electrode 34 and the thickness of the electron emitting region 32, the electron emission region 32 is also disposed lower by a certain or predetermined height difference than the upper surface of the first substrate 12.

The cathode electrode 34 may be formed through a suitable thin film process and/or a suitable thick film process. On the other hand, the gate electrode 36 is formed from a metal plate having a certain or predetermined thickness, and has a mesh structure with openings 361 formed therein for transmitting an electron beam. For example, the gate electrode 36 may be manufactured by the steps of cutting a metal plate having a given size into a stripe shape and then forming openings 361 on the metal plate by a method such as etching.

The gate electrode 36 may have openings 361 at portions that face the cathode electrodes 34 and at portions between the cathode electrodes 34, i.e., portions facing the first substrate 12 where the recession portion 38 is not formed on the basis of a state in which the gate electrode 36 is installed on the first substrate 12.

The gate electrodes 36, excluding lateral ends, form a mesh structure. This provides the benefit of not having to consider the alignment characteristic with the cathode electrodes 34 when fixing the gate electrodes 36 onto the first substrate 12. The gate electrodes 36 may be made of a nickel-iron alloy or another metal material.

The gate electrodes 36 are spaced apart and fixed to the upper surface of the first substrate 12 in a direction crossing the cathode electrodes 34. In this case, as the cathode electrode 34 and the electron emission region 32 are disposed in the recess portion 38 of the first substrate 12, insulation between the cathode electrodes 34 and the gate electrodes 36 can be ensured automatically by only fixing the gate electrodes 36 to the upper surface of the first substrate 12.

In the above-described structure, one crossing region of the cathode electrode 34 and the gate electrode 36 may correspond to one pixel area of the light emitting device 100, or two or more crossing regions may correspond to one pixel area. In the latter case, the cathode electrode electrodes located in the same pixel area are applied with the same driving voltage, and the gate electrodes 36 located in the same pixel area are also applied with the same driving voltage.

Next, the light emitting unit 30 includes an anode electrode 40 formed on an inner surface of the second substrate 14, a phosphor layer 42 disposed on one side of the anode electrode 40, and a reflective layer 44 that covers the phosphor layer 42.

The anode electrode 40 is formed of a transparent conductive material such as indium tin oxide (ITO) so that visible light emitted from the phosphor layer 42 can transmit through the anode electrode 40. The anode electrode 40 is an acceleration electrode that receives a high voltage (i.e., anode voltage) of thousands of volts or more to place the phosphor layer 42 at a high potential state so as to attract an electron beam.

The phosphor layer 42 may be formed of a mixture of red, green, and blue phosphors, which can collectively emit white light. The phosphor layer 42 may be formed on the entire active area of the second substrate 14, or may be divided into a plurality of sections corresponding to the pixel areas. FIG. 7 and FIG. 8 illustrate a case where the phosphor layer 42 is formed on the entire active area of the second substrate 14.

The reflective layer 44 may be an aluminum layer having a thickness of several thousands of angstroms (A) and having fine holes for transmitting an electron beam. The reflective layer 44 functions to enhance the luminance of the light emitting device 100 by reflecting visible light emitted from the phosphor layer 42 to the first substrate 12 toward the second substrate 14. The anode electrode 40 described above can be eliminated, and the reflective layer 44 can receive the anode voltage and function as the anode electrode.

Spacers 46 are between the substrates 12 and 14 and function to withstand a compression force applied to the vacuum chamber and to uniformly maintain the gap between the first and second substrates 12 and 14. The spacers 46 are correspondingly disposed between the gate electrodes 36.

The light emitting device 100 having the above-described structure applies a scan driving voltage to one of the cathode electrode 34 and the gate electrode 36, applies a data driving voltage to the other one, and applies an anode voltage of several thousands of volts or more to the anode electrode 40.

Then, an electric field is formed around the electron emission region 32 in pixels having a voltage difference between the cathode electrode 34 and the gate electrode 36 that is greater than a threshold value so that electrons are emitted therefrom. The emitted electrons, attracted by the anode voltage applied to the anode electrode 40, collide with a corresponding portion of the phosphor layer 42, thereby exciting the phosphor layer 42. Luminance of the phosphor layer 42 for each pixel corresponds to an electron beam emission amount of the corresponding pixel.

As above-described, as the gate electrodes 36 are disposed directly above the electron emission regions 32, electrons emitted from the electron emission regions 32 pass through the openings 361 of the gate electrodes 36 and reach the phosphor layer 4 with minimal beam diffusion. Accordingly, the light emitting device 100 of this exemplary embodiment can effectively suppress an electrical charging of the side walls of the recess portions 38 by reducing the initial diffusion angle of an electron beam.

As a result, the light emitting device 100 of this exemplary embodiment can stabilize driving by increasing withstand voltage characteristics of the cathode electrodes 34 and the gate electrodes 36, and can achieve high luminance by applying a voltage of 10 kV or more, and, in one embodiment, between about 10 to about 15 kV, to the anode electrode 40.

The light emitting device in FIG. 7 and FIG. 8 is an example of a light emitting device to which the above-described sealing member can be applied, and an internal structure of the light emitting device can be suitably modified.

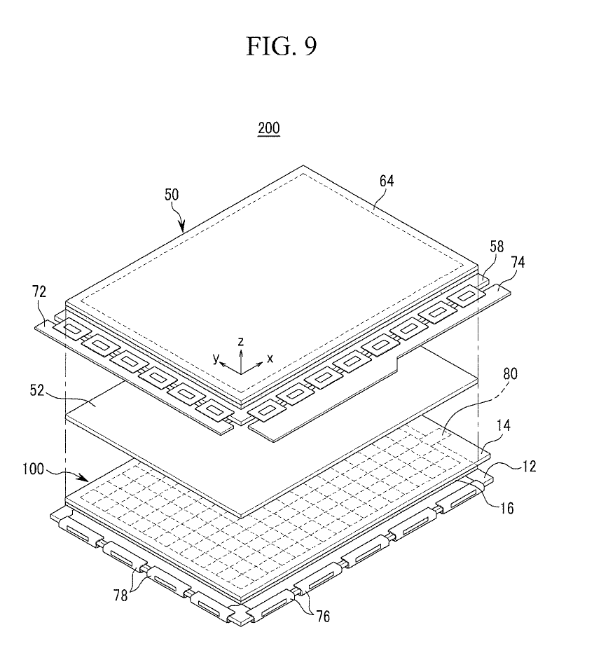

FIG. 9 is an exploded perspective view of a display device 200.

Referring to FIG. 9, the display device 200 includes a light emitting device having the above-described structure and a display panel 50 that is disposed in front of the light emitting device 100, receives light emitted from the light emitting device 100, and displays an image. The display panel 50 may be a transmissive or semi-transmissive liquid display panel. A diffuser 52 for uniformly diffusing light emitted from the light emitting device 100 may be disposed between the light emitting device 100 and the display panel 50.

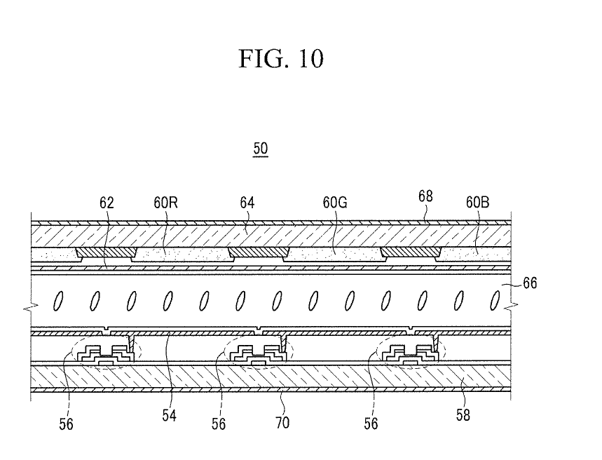

FIG. 10 is a partial cross-sectional view of the display panel of FIG. 9, and exemplarily shows a transmissive liquid crystal display panel. A case where the display panel 50 is a transmissive liquid crystal display panel is described in more detail with reference to FIG. 10.

Referring to FIG. 10, the display panel 50 includes a lower substrate 58 where pixel electrodes 54 and thin film transistors 56 are formed, an upper substrate 64 where color filter layers 60R, 60G, and 60B and a common electrode 62 are formed, and a liquid crystal layer 66 interposed between the upper substrate 64 and the lower substrate 58. Polarizing plates 68 and 70 are attached on a top surface of the upper substrate 64 and a bottom surface of the lower substrate 58 to polarize light passing through the display panel 50.

A pixel electrode 54 is provided to each sub-pixel, and is controlled by the thin film transistors 56. The pixel electrodes 54 and the common electrode 62 are formed of a transparent conductive material. The color filter layers 60R, 60G, and 60B include a red filter layer 60R, a green filter layer 60G, and a blue filter layer 60B provided to correspond to respective sub-pixels.

When the thin film transistor 56 of a specific sub-pixel is turned on, an electric field is formed between the pixel electrode 54 and the common electrode 62. The arrangement angle of liquid crystal molecules is varied by the electric field, and the light transmittance is varied in accordance with the varied arrangement angle. The display panel 50 can control the luminance and color for each pixel by this process.

Referring back to FIG. 9, reference numeral 72 represents a gate circuit board assembly that transmits a gate driving signal to a gate electrode of each thin film transistor, and reference numeral 74 represents a data circuit board assembly that transmits a data driving signal to a source electrode of each thin film transistor.

The light emitting device 100 includes a number of pixels that is less than the number of pixels of the display panel 50 so that one pixel of the light emitting device 100 corresponds to two or more pixels of the display panel 50. Each pixel of the light emitting device 100 may emit light in response to gray levels of the corresponding pixels of the display panel 50. In one example, each pixel of the light emitting device 100 may emit light in response to the highest gray level of the corresponding pixels of the display panel 50. Each pixel of the light emitting device 100 can represent gray levels of a gray scale between 2 and 8 bits.

For better understanding and ease of description, a pixel of the display panel 50 is referred to as a first pixel, a pixel of the light emitting device 100 is referred to as a second pixel, and first pixels corresponding to one second pixel are referred to as a first pixel group.

A driving operation of the light emitting device 100 may be as follows. \textcircled{1} A signal controller controlling the display panel 50 detects a highest gray level of the first pixels in the first pixel group. \textcircled{2} A gray level required for light emission of the second pixel depending on the detected gray level is calculated, and then converted to digital data. \textcircled{3} A driving signal of the light emitting device 100 is generated by using the digital data. \textcircled{4} The generated driving signal is applied to the driving electrodes of the light emitting device 100.

The driving signal of the light emitting device 100 may include a scan driving signal and a data driving signal. One of the cathode electrode 34 and the gate electrode 36 (for example, the gate electrode 36) receives the scan driving signal, and the other one (for example, the cathode electrode 34) receives the data driving signal.

The scan circuit board assembly and the data circuit board assembly for driving the light emitting device 100 may be disposed at a rear side of the light emitting device 100. In FIG. 9, reference numeral 76 represents a first connector that connects the cathode electrodes 34 and the data circuit board assembly, and reference numeral 78 represents a second connector that connects the gate electrodes 36 and the scan circuit board assembly. In addition, reference numeral 80 represents a third connector that applies an anode voltage to the anode electrode 40.

When an image is displayed at the first pixel group, the second pixel of the light emitting device 100 emits light of a certain or predetermined gray level synchronously with the first pixel group. That is, the light emitting device 100 provides light of a high luminance to a bright area in the image displayed by the display panel 50, and provides light of a low luminance to a dark area therein. Therefore, according to the display device 200 of the present exemplary embodiment, a constant ratio may be increased and image quality may be sharpened.

According to the exemplary embodiments, the respective supporting frames that form the sealing member are in a mechanical combination state and the supporting frames are completed to the sealing member through a follow-up process such as a thermal treatment process, and therefore individual movement of the supporting frames can be reduced or prevented during the thermal treatment process. Such a structure of the sealing member can substantially reduce or prevent movement of the supporting frames due to melting of the frit adhesive layers during the thermal treatment process.

Therefore, in the light emitting device according to the exemplary embodiments, the sealing member prevents a gap between the supporting frames from being generated so that secure vacuum sealing can be realized.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A light emitting device comprising:
a first substrate and a second substrate facing the first substrate; and
a sealing member between the first substrate and the second substrate,
wherein the sealing member comprises:
a first supporting frame having a first groove portion, and
a second supporting frame having an end inserted into the first groove portion, and
wherein an external surface of the end of the second supporting frame inserted into the first groove portion is surrounded by the first supporting frame.

2. The light emitting device of claim 1, wherein the first groove portion has a first depth that is smaller than the width of the first supporting frame, and the width of the first groove portion corresponds to the width of the second supporting frame.

3. The light emitting device of claim 2, wherein the sealing member further comprises frit adhesive layers on adhering surfaces of the first and second supporting frames and on top and bottom sides of the first and second supporting frames, facing the first and second substrates.

4. The light emitting device of claim 1, wherein the first supporting frame comprises a first side portion, and the second supporting frame comprises a second side portion connected to the first side portion and perpendicularly crossing the first side portion.

5. The light emitting device of claim 4, wherein the first side portion is a long side portion and the second side is a short side portion.

6. The light emitting device of claim 5, wherein the first groove portion is at an end and in an inner surface of the long side portion, and a second groove portion is at an end and in an inner surface of the short side portion.

7. The light emitting device of claim 5, wherein the second supporting frame has a second groove portion in which an end of the first supporting frame is inserted, and an external surface of the end of the first supporting frame inserted into the second groove portion is surrounded by the second supporting frame.

8. The light emitting device of claim 7, wherein the first groove portion of the first supporting frame is at an end and in an inner surface of the long side portion of the first supporting frame, and the second groove portion of the second supporting frame is at an end and in an inner surface of a long side portion of the second supporting frame.

9. The light emitting device of claim 7, wherein the first groove portion of the first supporting frame is at an end and in an inner surface of a short side portion of the first supporting frame, and the second groove portion of the second supporting frame is at an end and in an inner surface of the short side portion of the second supporting frame.

10. The light emitting device of claim 1, wherein the sealing member further comprises a third supporting frame and a fourth supporting frame, the second supporting frame has a second groove portion in which an end of the third supporting frame is inserted, the third supporting frame has a third groove portion in which an end of the fourth supporting frame is inserted, the fourth supporting frame has a fourth groove portion in which an end of the first supporting frame is inserted, and external surfaces of the ends of the third, fourth, and first supporting frames are surrounded by the second, third, and fourth supporting frames.

11. The light emitting device of claim 10, wherein each of the first, second, third, and fourth supporting frames has a bar shape.

12. The light emitting device of claim 11, wherein the first groove portion of the first supporting frame is at an end and in an inner surface of the first supporting frame, the second groove portion of the second supporting frame is at an end and in an inner surface of the second supporting frame, the third groove portion of the third supporting frame is at an end and in an inner surface of the third supporting frame, and the fourth groove portion of the fourth supporting frame is at an end and in an inner surface of the fourth supporting frame.

13. The light emitting device of claim 1, further comprising an electron emitting unit at one side of the first substrate facing the second substrate,
wherein the electron emitting unit comprises:
a cathode electrode in a recess portion in the one side of the first substrate;
an electron emission region on the cathode electrode; and
a gate electrode fixed onto the one side of the first substrate along a direction that crosses the cathode electrode, and having a mesh structure comprising a plurality of openings.
